(19) United States
(12) Patent Application Publication
(10) Pub. No.: US 2018/0005713 A1
(43) Pub. Date: Jan. 4, 2018

(54) AIR CIRCULATING DEVICE BELOW STEAM GENERATOR OF NUCLEAR REACTOR

(71) Applicant: In Dug MOON, Uljin-gun Gyeongsangbuk-do (KR)

(72) Inventor: In Dug MOON, Uljin-gun Gyeongsangbuk-do (KR)

(21) Appl. No.: 15/542,370

(22) PCT Filed: Dec. 8, 2015
(86) PCT No.: PCT/KR2015/013373

§ 371 Date: Jul. 7, 2017

(30) Foreign Application Priority Data
Jan. 29, 2015 (KR) 10-2015-0014055

(51) Int. Cl. G21C 15/26; G21C 15/16

(52) U.S. Cl. CPC G21C 15/26; G21C 15/16

(57) ABSTRACT

The present invention provides an air circulating sleeve device that is provided below a steam generator to prevent thermal deformation of a sliding base that supports the steam generator of a nuclear reactor, the air circulating sleeve device comprising: a through-hole formed at the center of the sliding base; and a sleeve vertically mounted so as to be aligned with the through-hole, wherein thermal deformation of the sliding base is prevented by performing natural cooling by introducing external air below the sliding base into a stagnated air area inside the sliding base and a skirt support through the sleeve, and the skirt support includes at least one vent hole such that the stagnated air area inside the sliding base and the skirt support is exposed to the air outside the skirt support, and natural circulation of air is performed through the vent hole.

### FIELD OF THE INVENTION

The present invention relates to a sleeve device for circulating air in a stagnated air area disposed below a steam generator of a nuclear reactor and, more particularly, to an air circulating sleeve device below a steam generator of a nuclear reactor, wherein the air circulating sleeve device is for preventing vibrating of the nuclear reactor due to thermal expansion deformation of a sliding base, by naturally circulating air through the Venturi Effect by having an air circulating sleeve mounted at the center of the sliding base supporting the steam generator of the nuclear reactor, naturally cooling a stagnated air area inside a stay cylinder and a skirt support of the steam generator, and effectively preventing the transfer of high-temperature heat from the steam generator to the sliding base.

### BACKGROUND OF THE INVENTION

In general, Korean examples of nuclear reactors include System Plus 80 (Hanbit units 3 and 4) by Conbustion Engineering (CE), Korean Standard Nuclear Power Plant (Hanul units 3, 4, 5, and 6 and Hanbit units 5 and 6), OPR1000 (Shin-Kori units 1 and 2), APR1400 (Shin-Kori units 3 and 4, Shin-Uljin units 1 and 2, and UAE nuclear power plants 1-4), and a 2-loop Pressurized Water Reactor.

Typically, nuclear reactor power plants (hereinafter called “nuclear reactors” for the sake of brevity) have a reactor coolant system (RCS) inside a containment building, which is also set forth in “Pipe Supporting Device for Replacing Components in Nuclear Power Plant” of Korean Registered Patent No. 10-1473665. Such nuclear reactor coolant systems have a reactor containing a nuclear reactor, and at least one heat transfer circuit connected to the reactor.

Each circuit includes a steam generator, a reactor, and at least one coolant pump for circulating coolant between the reactor and the steam generator.

In addition, the circuit includes a compressor for uniformly maintaining the temperature and pressure of the coolant. A first large-diameter pipe or a hot leg is connected to one side of a reactor and one side of an inlet of a coolant chamber and contacts a core inside the reactor, and transfers heated coolant to the steam generator.

A circulation pipe known as a cross-over leg is connected to one side of an outlet of a coolant chamber of the steam generator and one side of a vortex chamber inlet of a coolant pump. Also, the cold leg connects the vortex chamber of the coolant pump and the reactor. The coolant that is cooled in the steam generator and withdrawn by the coolant pump is transferred through a circulation pipe and a low temperature pipe into the reactor to cool the core.

In such a nuclear reactor, each steam generator (1) has a lower structure as illustrated in FIG. 1.

In particular, the steam generator (1) is provided with a stay cylinder (10) that is maintained in a high-temperature state, and a cylindrical skirt support (20) that holds up the stay cylinder (10) from below.

The skirt support (20) is fixed and supported on a sliding base (30) at the bottom thereof by a plurality of stud bolts (32), and the sliding base (30) is supported on a plurality of—for example—4 semispherical sliders (42) provided on a forged anchor plate (40) and a bearing plate (41), so as to accommodate small movements that occur during the operation of the nuclear reactor.

As the steam generator (1) generates high-temperature heat during operation, a heat insulator (50) for preventing the high-temperature heat from being transferred to the sliding base (30) below is mounted on the stay cylinder (10) and skirt support (20) portions.

Such a prior art sliding base (30) structure is illustrated in detail in FIG. 2.

FIG. 2 illustrates the floor surface of a sliding base (30), wherein a plurality of stud bolt holes (52) are formed in the center, slider sockets (54) in which semispherical sliders (42) are respectively located are disposed thereabove, and a plurality of key holes (56) are formed in which keys (46) that protrude on a forged anchor plate (40) are located (refer to FIG. 1).

Accordingly, such a related art sliding base (30) is anchored and coupled to the skirt support (20) above the sliding base (30) by positioning stud anchors (32) through the plurality of stud bolt holes (52), respectively, such that the structure is one in which a steam generator (1) is seated on the sliding base (30).

During the operation of such a steam generator (1), high-temperature heat of typically 300° C. or greater is generated inside a stay cylinder (10), and this high-temperature heat is transferred downward to thermally deform the sliding base (30).

While the heat insulator (50) is installed below the stay cylinder (10) to prevent such deformation, the heat insulator (50) is incapable of completely blocking the heat, and the sliding base (30) is heated and thermally deformed due to many reasons, such as heat being directly conducted through the skirt support (20).

In particular, the skirt support (20) of the steam generator (1) is a cylindrical supporting steel structure and is therefore a structure inside which a stagnated air area (80) is formed.

That is, the stagnated air area (80) has the heat insulator (50) of the stay cylinder (10) located at the top, the skirt support (20) located at the perimeter, and the top surface central area of the sliding base (30) disposed at the bottom, so as to form an enclosed space.

The stagnated air area (80) acts as a space that radiates high-temperature heat from the steam generator (1), and thus presents the problem of causing serious thermal deformation of the sliding base (30).

The related problems are described in detail below.

In particular, thermal deformation of the sliding base (30) suppresses free movement caused by thermal expansion of the sliding base (30) that occurs during power plant operation, or causes interference with surrounding structures at the upper portion of the steam generator (1), thereby leading to structural vibration of the steam generator (1) and a coolant pump.

Such structural vibration causes fretting wear and vibration stress to the steam generator (1), and prolonged operation induces fatigue in small diameter pipes which are subjected to boric acid embrittlement due to the accumulation of boric acid, such that leakage of boric acid solution occurs.

Also, as an element of nuclear reactor piping construction, the final connection weld of the steam generator (1) to an intermediate pipe leaves a residual load on the sliding base (30) and a pump vertical support due to weld shrinkage. As a result of this residual load, settling of the sliding base (30) occurs due to weld shrinkage, and there is typically settling within a range of about 1 mm from after the installation of the steam generator (1) to after the final connection welding.

This amount of settling may be seen as the residual load on the sliding base (30), and the residual load increases the frictional force on the sliding base (30) at the beginning of nuclear reactor startup and has the characteristic of reducing transverse sliding movement.

Moreover, when the sliding base (30) is thus thermally deformed, the steam generator (1) is made to operate while leaning, and even after cold shutdown, misalignments between components may continuously appear.

Resultantly, when the sliding base (30) is deformed and cannot be maintained level, the steam generator (1) leans, and the deformation and interference of the supporting structures for the nuclear reactor coolant pump and the steam generator (1) will further add to vibration stress on the nuclear reactor.

This vibration stress is not only the cause of fretting wear of the steam generator (1), but causes wear of the internal components of the nuclear reactor coolant pump and increases fatigue on pipes connected to an RCS system and causes fatigue cracking. This frequently occurs during the operation of foreign nuclear power plants.

When operated in such a state over extended periods, leakage occurs at the mechanical seals and small-diameter pipes of nuclear reactor coolant pumps.

Accordingly, there is a pressing need in this field to develop a technology capable of preventing thermal deformation of the sliding base (30) of a nuclear reactor and preventing fretting wear of the steam generator (1) due to structural vibration of the nuclear reactor, and preventing wear of nuclear reactor coolant system equipment.

### SUMMARY OF THE INVENTION

An object of the present invention is to solve the above-described problem of the related art and is to provide an air circulating sleeve device below a steam generator, which applies a stagnated air area, formed in an inner space of a sliding base and a skirt support, as a natural air circulating structure and introduces external air below the sliding base to perform natural cooling, so as to significantly reduce the amount of high-temperature heat transferred to the sliding base and effectively prevent thermal deformation of the sliding base.

Another object of the present invention is to provide an air circulating sleeve device below a steam generator, which discharges high-temperature heat in a stagnated air area below the steam generator to the outside and performs natural cooling, so as to significantly reduce the amount of high-temperature heat transferred to a sliding base, and effectively prevent thermal deformation of the sliding base.

To achieve the above objects, the present invention provides an air circulating sleeve device below a nuclear reactor steam generator, the device for preventing thermal deformation of a sliding base supporting the steam generator, and comprising: a through-hole formed at a center of the sliding base; and a sleeve vertically mounted to be aligned with the through-hole, wherein thermal deformation of the sliding base is prevented by performing natural cooling by introducing external air below the sliding base into a stagnated air area inside the sliding base and a skirt support through the sleeve, and the skirt support includes at least one vent hole such that the stagnated air area inside the sliding base and the skirt support is exposed to the air outside the skirt support, and natural circulation of air is performed through the vent hole.

Also, preferably in the present invention, the sleeve has a one-piece configuration having top and bottom end portions thereof protruding upward and downward, respectively, from the sliding base and having a mounting flange formed at an outer surface center thereof, and fixed to the sliding base.

In addition, preferably in the present invention, the sleeve has an assemblable/disassemblable, two-piece configuration having an upper pipe protruding upward from the sliding base and a lower pipe protruding downward from the sliding base, connecting flanges are formed respectively at connecting portions of the upper and lower pipes and fixed through bolting, and the upper pipe is detachable/attachable in a state in which the lower pipe is fixed to the sliding base.

Further, preferably in the present invention, the sleeve has a Venturi passage formed therein such that the Venturi Effect is imparted to air passing through the sleeve, and the speed of flowing air is accelerated to improve air circulating effects.

Still further, preferably in the present invention, the sleeve has a neck portion formed at and proximal to a top end portion of the sleeve and having a decreasing inner diameter, such that the Venturi Effect is imparted, and the speed of flowing air is accelerated to improve air circulating effects in the stagnated air area.

According to the present invention, a through-hole is formed in the center of a sliding base supporting a steam generator, a sleeve that is aligned with the through-hole and vertically mounted is included so as to introduce external air from below the sliding base, and a skirt support defines at least one vent hole so as to naturally circulate high-temperature heat in a stagnated air area to the outside of the skirt support and perform cooling.

Thus, according to the present invention, the following remarkable effects may be obtained. The amount of high-temperature heat transferred from the steam generator to the sliding base may be significantly reduced, such that thermal deformation of the sliding base may be effectively prevented, and structural vibration of the nuclear reactor may be prevented so as to enable the effective prevention of fretting wear of the steam generator and wear of nuclear reactor coolant system equipment.

Also, according to the present invention, a Venturi passage is formed inside the sleeve so as to impart air passing through the sleeve with the Venturi Effect. Thus, the remarkable effects may be obtained in which the flow speed of naturally circulating external air introduced to a stagnated air area from the lower portion of the sliding base to the upper portion of the sliding base may be accelerated to further improve air circulating effects.

### BRIEF DESCRIPTION OF THE DRAWINGS

FIG. 1 is a cross-sectional view illustrating the lower structure of a steam generator according to the related art.

FIG. 2 is a bottom view illustrating a lower sliding base structure of a steam generator according to the related art.

FIG. 3 is a cross-sectional view illustrating a structure in which an air circulating sleeve device at the lower portion of a steam generator is mounted on a sliding base, according to the present invention.

FIG. 4 is an exploded view illustrating a coupling structure of an air circulating sleeve device and a sliding base at the lower portion of a steam generator, according to the present invention.

FIGS. 5a and 5b are a perspective view and a coupled cross-sectional view illustrating the structure of an air circulating sleeve device having a one-piece configuration at the lower portion of a steam generator, according to the present invention.

FIGS. 6a and 6b are a perspective view and a coupled cross-sectional view illustrating the structure of an air circulating sleeve device having a separable two-piece configuration at the lower portion of a steam generator, according to the present invention.

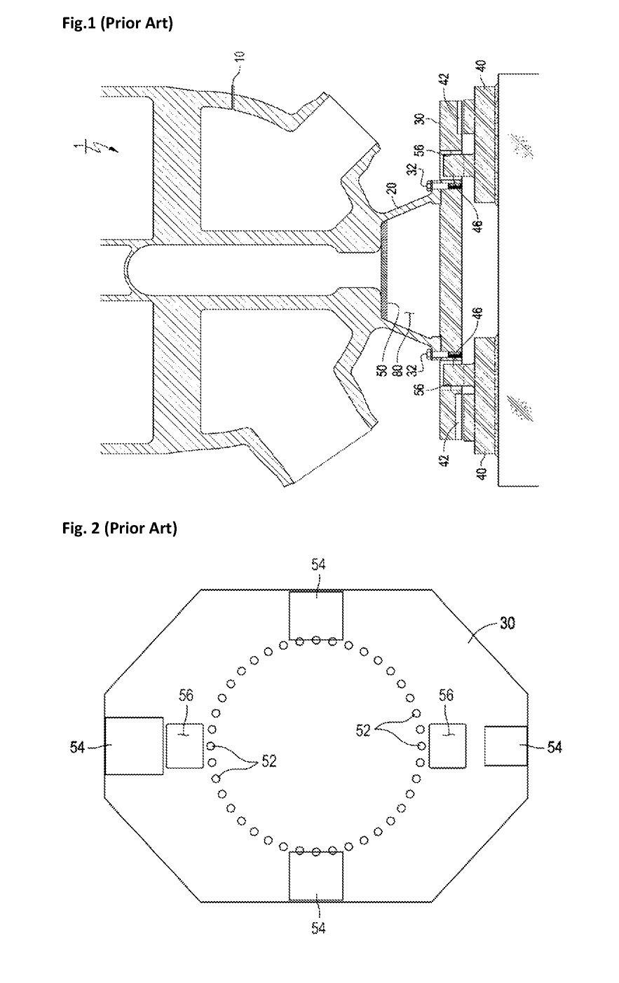

### DETAILED DESCRIPTION

Hereinafter, preferred embodiments of the present invention will be described in further detail with reference to the drawings.

An air circulating sleeve device (100) at the lower portion of a steam generator according to the present invention is a device for preventing thermal deformation of a sliding base (30) supporting a nuclear reactor steam generator (1) and preventing vibrating of the nuclear reactor.

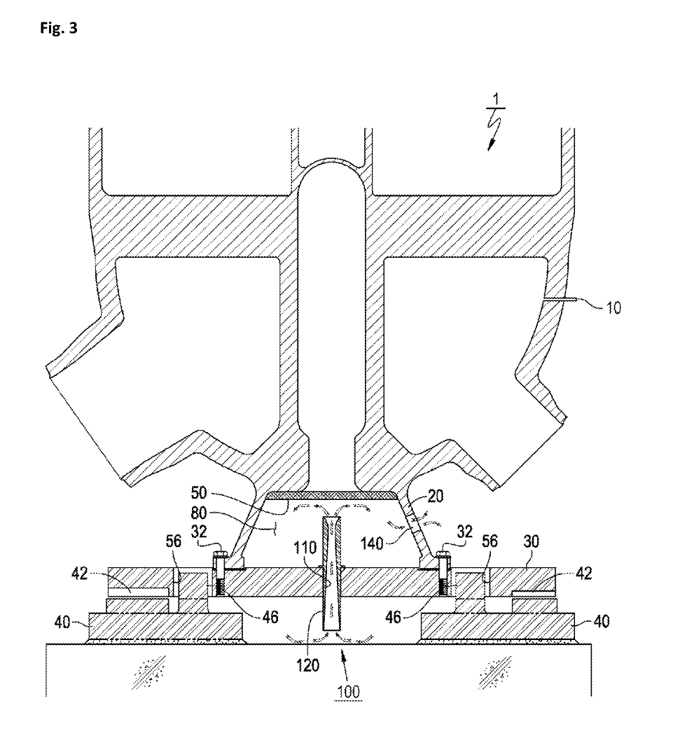

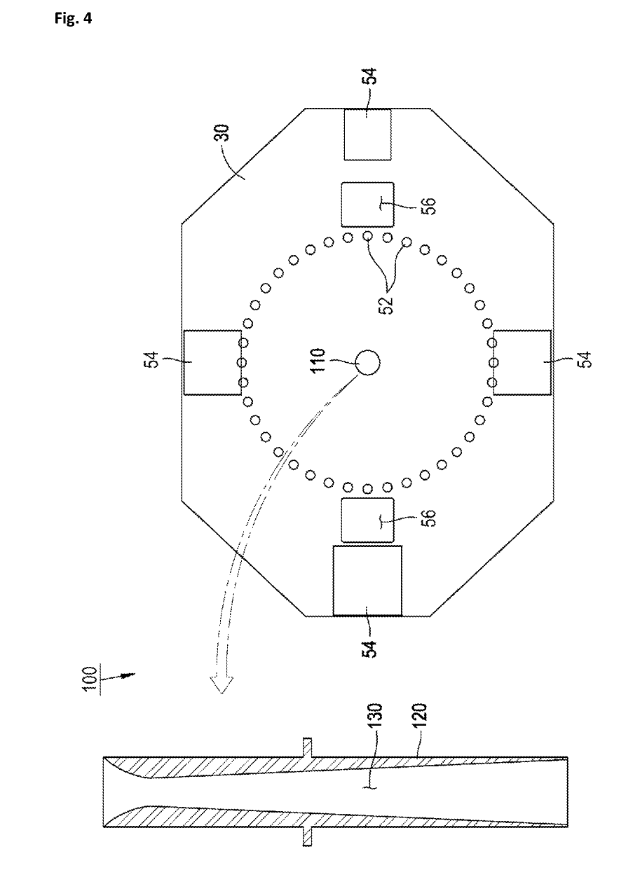

The air circulating sleeve device (100) at the lower portion of the steam generator according to the present invention, as illustrated in FIGS. 3 and 4, is a structure having a through-hole (110) formed in the center of the sliding base (30), and a sleeve (120) aligned with the through-hole (110) and mounted vertically.

In particular, the air circulating sleeve device (100) at the lower portion of the steam generator according to the present invention, as illustrated in FIG. 4, is a structure differing from existing structures in that the sleeve (120) is mounted vertically in the through-hole (110) in the center of the sliding base (30), and introduces external air from below the sliding base (30) into a stagnated air area (80) inside the sliding base (30) and a skirt support (20), and performs natural cooling.

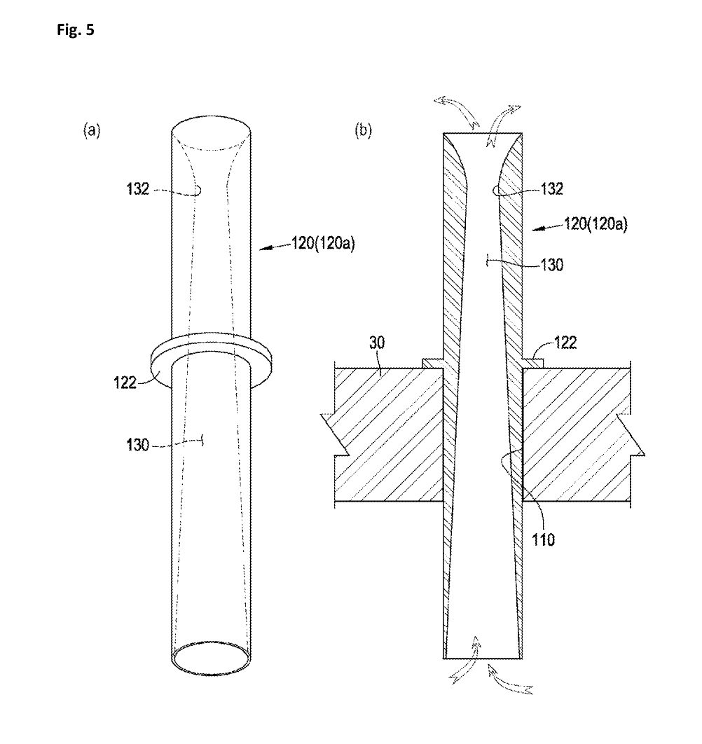

The sleeve (120) may preferably have a pipe-shaped one-piece configuration or a two-piece configuration that divides vertically. When the sleeve (120) is a one-piece member (120a), which is illustrated in FIGS. 5a and 5b, the sleeve has a pipe shape of which the top and bottom end portions protrude a certain length upward and downward, respectively, from the sliding base (30), and which has a mounting flange (122) formed on the outer surface at the middle thereof so as to be fixed on the sliding base (30).

Thus, when the sleeve (120) has a long pipe shape that protrudes certain lengths upward and downward from the sliding base (30), the height differences at the top and bottom end portions thereof are maintained, and the Chimney Effect is implemented in which a natural airflow is formed between the top and bottom end portions.

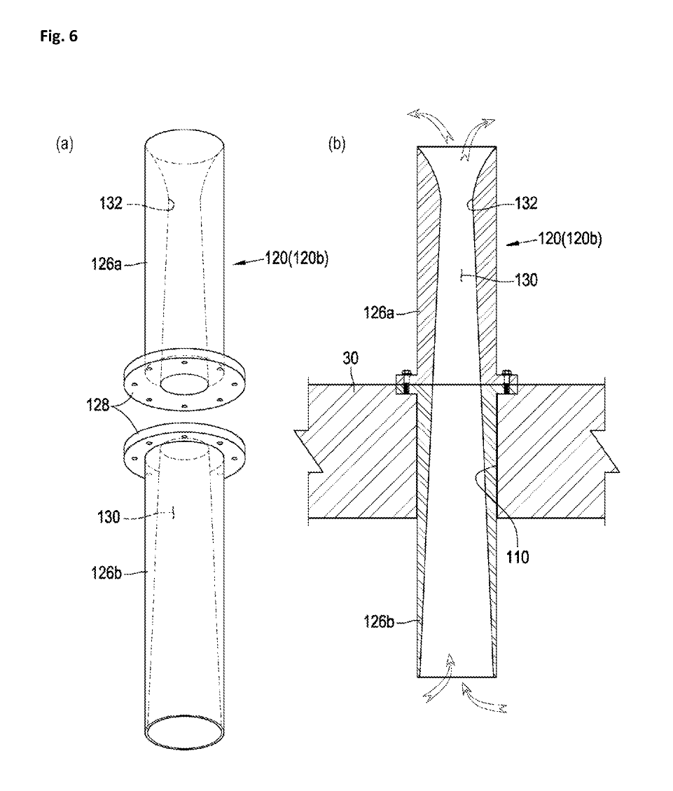

When the sleeve (120) is a two-piece member (120b), as illustrated in FIGS. 6a and 6b, the sleeve (120) is an assemblable/disassemblable structure having a two-piece pipe shape consisting of an upper pipe (126a) protruding upward from the sliding base (30) and a lower pipe (126b) protruding downward from the sliding base (30), and connecting flanges (128) are respectively formed at the connecting portions of the upper and lower pipes (126a and 126b) and fixed through bolting, such that the upper pipe (126a) may be detached/attached in a state in which the lower pipe (126b) is fixed to the sliding base (30).

Even in this structure in which the sleeve (120) is formed in two pieces, the upper and lower pipes (126a and 126b) are connected to each other to form a long pipe shape and provide the Chimney Effect.

Moreover, this two-piece member (120b) is particularly useful during inspection and maintenance and repair of the steam generator (1) equipment.

For example, various fault inspections such as weld inspections are performed regularly or arbitrarily for the welded portions of the stay cylinder (10) and the skirt support (20) of the steam generator (1) equipment, and various pieces of equipment are disposed at the center of the sliding base (30).

In such cases, the upper pipe (126a) is separated from the lower pipe (126b), enabling unimpeded use of inspection equipment. After the inspection is completed, the upper and lower pipes may be reassembled. Thus, the disassemblable structure of the two-piece member is extremely useful.

These sleeves (120) both have Venturi passages (130) formed therein for accelerating the circulation of air flowing therein, and a neck portion (132) having a reduced diameter is formed at the inner diameter side near the top end portion of the sleeve (120), so as to provide the Venturi effect at the top end portion of the sleeve (120), or adjacent to the stagnated air area (80).

This Venturi passage (130) is a standard structure and is typical in that the respective inner diameters from the top and bottom ends of the sleeve (120) gradually decrease toward the neck portion (132).

Resultantly, during the process in which air flows inside the Venturi passage (130), the speed builds to a maximum at the neck portion (132) to form a fast flow of air, which greatly diffuses high-temperature air inside the stagnated air area (80).

Thus, the sleeve (120) is capable of further improving air circulating effects and increasing natural cooling effects when airflow is accelerated at the top end of the sleeve (120) in the stagnated air area (80), when external air below the sliding base (30) is introduced into the stagnated air area (80) by virtue of a convection current brought about by a temperature difference between the stagnated air area (80) inside the sliding base (30) and the skirt support (20) and the external air below the sliding base (30).

Meanwhile, the air circulating sleeve device (100) below the steam generator according to the present invention includes at least one vent hole (140) in the skirt support (20), through which the stagnated air area (80) inside the sliding base (30) and the skirt support (20) is made to communicate with the air outside the skirt support (20).

This vent hole (140) may be configured in the form of open holes formed along the circumference of the skirt support (20), and such vent holes (140) may also function as man-ways through which workers enter the skirt support (20).

Accordingly, such a vent hole (140), together with the sleeve (120) provided on the sliding base (30), forms a natural circulation passage, through which external air below the sliding base (30) flows through the stagnated air area (80) to the outside of the skirt support (20).

The air circulating sleeve device (100) below the nuclear reactor steam generator according to the present invention as configured above, as illustrated in FIG. 3, has a through-hole (110) formed in the center of the sliding base (30), a sleeve (120) aligned with the through-hole and mounted vertically, and at least one vent hole (140) formed in the skirt support (20), such that high-temperature heat in the stagnated air area (80) is naturally circulated by external air and cooled.

Particularly, in such an air circulating and cooling process, the sleeve (120) has the Venturi passage (130) formed therein so as to impart the Venturi Effect to air passing through the sleeve (120) and accelerate the speed of flowing air to enable air circulating effects to be improved.

Therefore, according to the present invention, high-temperature heat transferred from the steam generator (1) to the sliding base (30) may be greatly reduced, which may effectively prevent thermal deformation of the sliding base (30), and may prevent structural vibration of the nuclear reactor so as to effectively prevent fretting wear of the steam generator (1) and wear of nuclear reactor coolant system equipment.

While the present invention has been described in detail above with respect to specific embodiments and with reference to the drawings, the present invention shall not be limited to such specific configurations. A person with ordinary skill in the art will be able to diversely modify or change the present invention without departing from the technical spirit and protective scope of the present invention as set forth in the scope of the claims below. For example, while one sleeve (120) has been illustrated and described as mounted at the center of the sliding base (30), the sleeve (120) may be provided in plurality instead of the singular. Also, instead of the technique of naturally circulating air through the Venturi Effect, a configuration may be employed in which a temperature sensor is mounted in the stagnated air area inside the skirt support, and when the temperature sensor senses that the temperature has reached a preset specific temperature, the air inside the skirt support is forcibly discharged. It shall be noted in advance, however, that such simple design modifications or structural changes will all clearly fall within the protective scope of the present invention.

What is claimed:

1. An air circulating sleeve device below a nuclear reactor steam generator, the device for preventing thermal deformation of a sliding base supporting the steam generator, and comprising: a through-hole formed at a center of the sliding base; and a sleeve vertically mounted to be aligned with the through-hole, wherein thermal deformation of the sliding base is prevented by performing natural cooling by introducing external air below the sliding base into a stagnated air area inside the sliding base and a skirt support through the sleeve, and the skirt support includes at least one vent hole such that the stagnated air area inside the sliding base and the skirt support is exposed to the air outside the skirt support, and natural circulation of air is performed through the vent hole.

2. The air circulating device below the steam generator of claim 1, wherein the sleeve has a one-piece configuration having top and bottom end portions thereof protruding upward and downward, respectively, from the sliding base and having a mounting flange formed at an outer surface center thereof, and fixed to the sliding base.

3. The air circulating sleeve device below the steam generator of claim 1, wherein the sleeve has an assemblable/disassemblable, two-piece configuration having an upper pipe protruding upward from the sliding base and a lower pipe protruding downward from the sliding base, connecting flanges are formed respectively at connecting portions of the upper and lower pipes and fixed through bolting, and the upper pipe is detachable/attachable in a state in which the lower pipe is fixed to the sliding base.

4. The air circulating sleeve device below the steam generator of claim 2, wherein the sleeve has a Venturi passage formed therein such that the Venturi Effect is imparted to air passing through the sleeve, and the speed of flowing air is accelerated to improve air circulating effects.

5. The air circulating sleeve device below the steam generator of claim 4, wherein the sleeve has a neck portion formed at and proximal to a top end portion of the sleeve and having a decreasing inner diameter, such that the Venturi Effect is imparted, and the speed of flowing air is accelerated to improve air circulating effects in the stagnated air area.

6. The air circulating sleeve device below the steam generator of claim 3, wherein the sleeve has a Venturi passage formed therein such that the Venturi Effect is imparted to air passing through the sleeve, and the speed of flowing air is accelerated to improve air circulating effects.

7. The air circulating sleeve device below the steam generator of claim 6, wherein the sleeve has a neck portion formed at and proximal to a top end portion of the sleeve and having a decreasing inner diameter, such that the Venturi Effect is imparted, and the speed of flowing air is accelerated to improve air circulating effects in the stagnated air area.
